(19) United States
(12) Patent Application Publication
(10) Pub. No.: US 2007/0034663 A1
(43) Pub. Date: Feb. 15, 2007

(54) Firing pin for a nailing gun

(76) Inventor: Fwu-Lai Wey, Taichung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/429,690

(22) Filed: May 8, 2006

(30) Foreign Application Priority Data
Jul. 26, 2005 (TW) 094212662

(51) Int. Cl. B25C 1/04

(52) U.S. Cl. 227/130; 227/156

(57) ABSTRACT

A firing pin for a nailing gun has a head and a shaft, wherein the head has a cushion attached thereon to operationally abut a pad on inner wall of the nailing gun. Therefore, not only the pad provides a damping capability but also the cushion provides an additional buffering efficiency to reduce vibration and impact and to protect the firing pin from damage. Thereby, lifespan of the firing pin and the pad are significantly prolonged.

### BACKGROUND OF THE INVENTION

1. Field of the Invention

The present invention relates to a firing pin, and more particularly to a firing pin for a nailing gun that has excellent damping efficiency to avoid damage during operation and prolong lifetime itself.

2. Description of Related Art

Conventional nailing gun has its firing pin punching outward when the nailing gun fires. Because the punching force is strong, vibration and impact cause the firing pin to be damaged after punching. Although a pad is attached inside the conventional nailing gun to server as a buffer, the damping efficiency is not enough so that the firing pin and the pad have to be changed often. This is not economic for nailing gun user.

According to above description, the conventional nailing gun still has some drawbacks not resolved.

### SUMMARY OF THE INVENTION

A main objective of the present invention is to provide a firing pun for a nailing gun that has excellent damping efficiency to avoid damage itself.

To achieve the foregoing objective, the firing pin comprises:

a head with a recess;

a shaft erectly attached to the head within the recess; and

an annular cushion partially received inside the recess, surrounding the shaft and adapted to operationally abut the pad when the nailing gun fires to reduce impact.

By having the annular cushion on the head to abut the pad, an excellent damping efficiency is provided to keep the firing pin from being damaged when the nailing gun fires. Thus, the lifespan of the firing pin is prolonged.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a firing pin for a nailing gun in accordance with the present invention;

FIG. 2 is an exploded cross-sectional side view of the firing pin in FIG. 1;

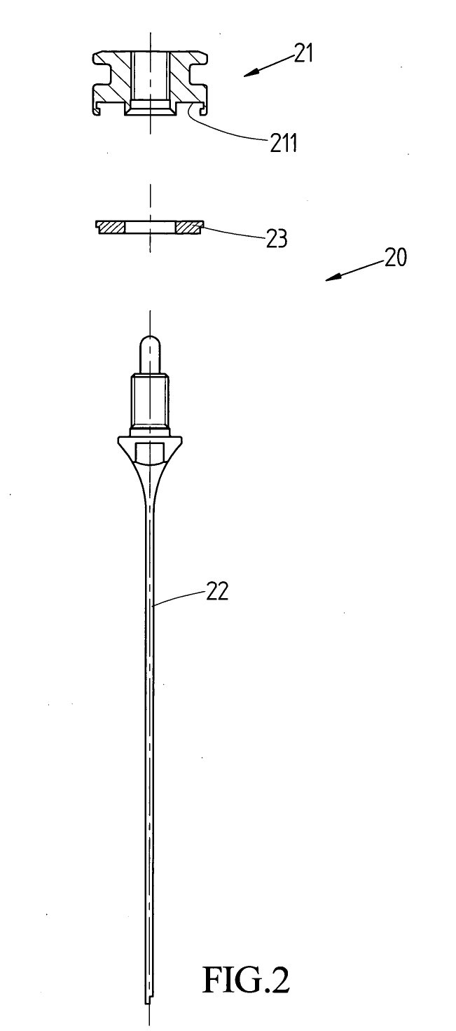

FIG. 3 is an exploded cross-sectional side view of a modified embodiment of the firing pin for a nailing gun in accordance with the present invention;

FIG. 4 is an operational cross-sectional side view of a nailing gun with the firing pin before the nailing gun fires; and

FIG. 5 is an operational cross-sectional side view of the nailing gun with the firing pin after the nailing gun fires.

### DETAILED DESCRIPTION OF THE PREFERRED EMBODIMENT

A firing pin for a nailing gun in accordance with the present invention comprises a head and a shaft, wherein the head has a cushion attached to operationally abut a pad on inner wall of the nailing gun. Therefore, not only the pad provides a damping capability but also the cushion provides an additional damping efficiency to reduce vibration and impact and to protect the firing pin from damage. Thereby, lifespan of the firing pin and the pad are significantly prolonged.

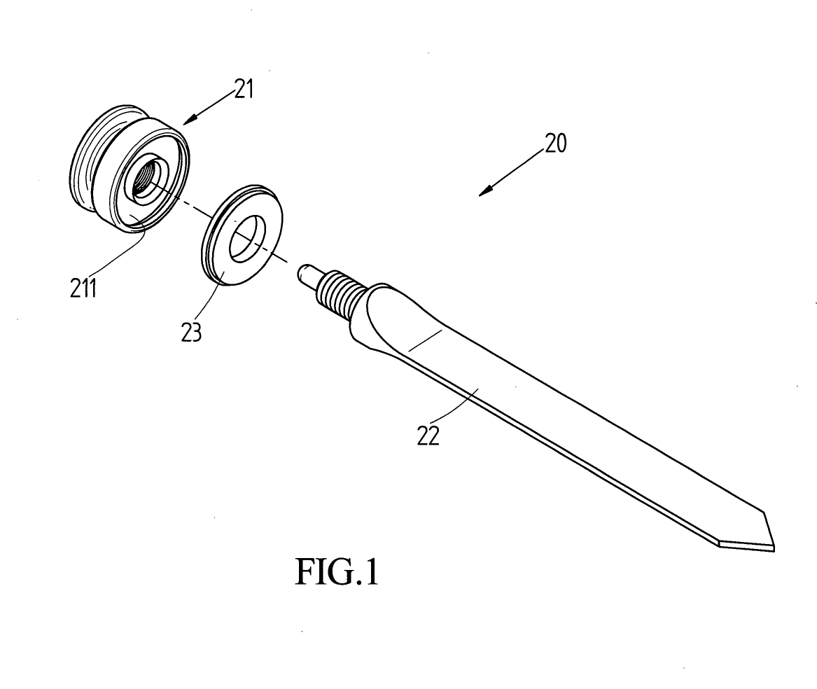

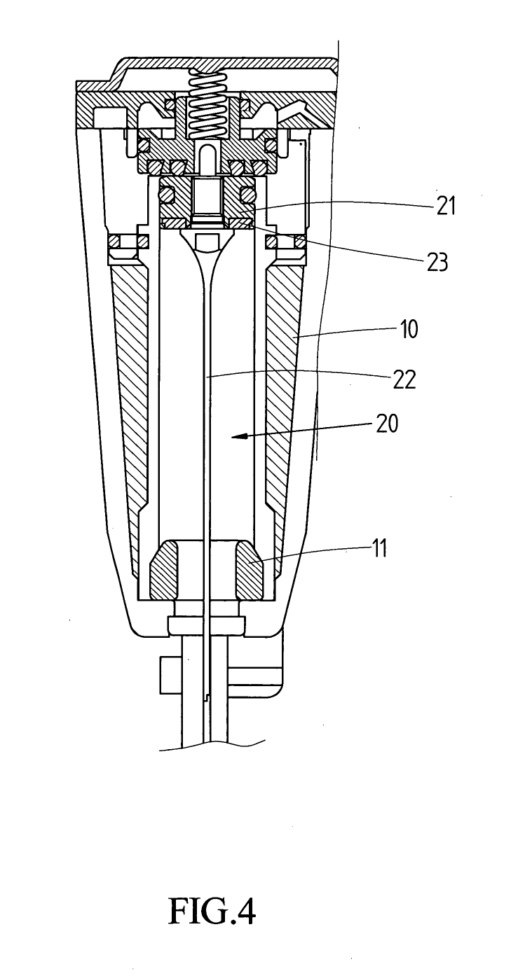

With reference to FIGS. 1 and 4, a preferred embodiment of the firing pin 20 for a nailing gun in accordance with the present invention is accommodated inside a chamber 10 with a pad 11 and comprises a head 21 and a shaft 22. The pad 11 inside the chamber 10 the firing pin 20 movably penetrating therethrough when the nailing gun fires.

The head 21 is cylindrical and has a front face, a recess 211 defined on the front face, and an annular cushion 23 partially accommodated inside the recess 211. Moreover, the head 21 has a threaded hole defined at a central axle thereof. The shaft 22 is shaped as a sword with a front flat end and a rear round end, wherein a threaded protrusion formed and longitudinal to the rear round end. When the head 21 combines with the shaft 22, the threaded protrusion detachably engaged with the threaded hole on the head 21. Thereby, the annular cushion 23 is partially clamped between the head 21 and the rear round end of the shaft 22 to provide the damping efficiency, wherein the annular cushion 23 is made of rubber or plastic such as polyurethane (PU).

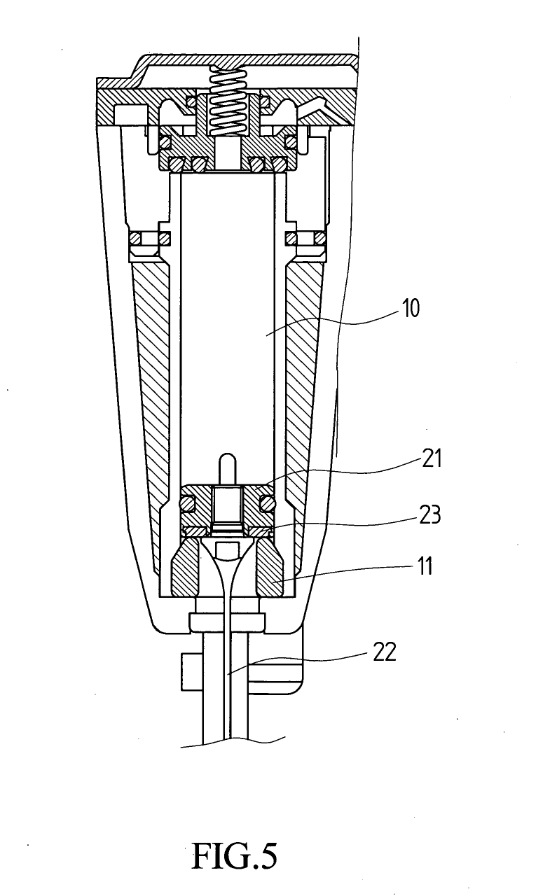

With reference to FIGS. 4 and 5, when the nailing gun operates, the firing pin 20 swiftly moving forward until the head 21 abuts the pad 11 at a front end of the chamber 10. Particularly, the annular cushion 23 on the head 21 directly contacts with the pad 11 inside the chamber 10 to provide an additional damping efficiency to avoid impact damage of the firing pin 20.

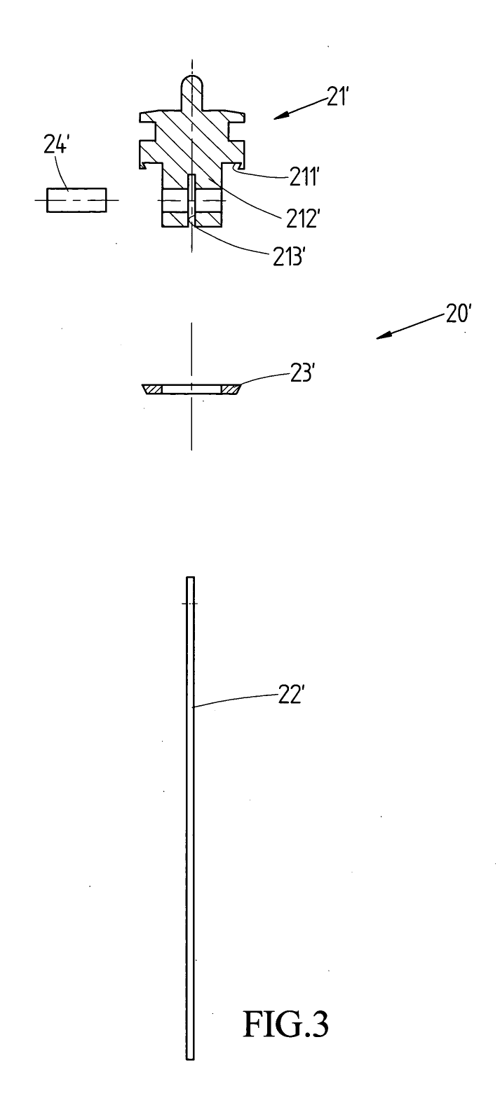

With reference to FIG. 3, another preferred embodiment of the firing pin 20′ is shown that substantially has the similar structure of the foregoing one. The head 21′ has a recess 211′ and a central post 212′ extending out of the recess 211′. The central post 212′ has an insertion hole 213′ axially defined therein. The annular cushion 23′ surrounds the central post 212′ and is partially received inside the recess 211′. The shaft 22′ is modified into a flat strip and has a rear end engaged with the insertion hole on the central post 212′ of the head 21′. Therefore, a positioning pin 24′ transversally penetrates through the central post 212′ and the shaft 22′ and is riveted to serve as a fastening element. Particularly, two ends of the positioning pin 24′ must be flushed with periphery of the central post 212′ in case the movement of the firing pin 20′ is interfered.

According to above description, the preferred embodiments of the firing pins in the present invention respectively have the annular cushion 23, 23′ to provide the further damping efficiency when the nailing gun fires. Therefore, vibration and impact of firing are significantly reduced to avoid the firing pin 20, 20′ from being damaged.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A firing pin movably received within a chamber with a pad inside a nailing gun, the firing pin comprising:
a head with a recess;
a shaft erectly attached to the head within the recess; and
an annular cushion partially received inside the recess, surrounding the shaft and adapted to operationally abut the pad when the nailing gun fires to reduce impact.

2. The firing pin as claimed in claim 1, wherein the shaft has a rear round end, a front flat end integrally formed with the rear round end, and a threaded protrusion formed longitudinally on the rear round end;
the head has a threaded hole axially defined inside the head to engage the threaded protrusion of the shaft.

3. The firing pin as claimed in claim 1, wherein the shaft is a flat strip;
the head further has a central post extending out of the recess, an insertion hole axially defined in the central post to engage the shaft, and a positioning pin riveted to penetrate and secure the head and the shaft together.

4. The firing pin as claimed in claim 1, wherein the annular cushion is made of rubber.

5. The firing pin as claimed in claim 1, wherein the annular cushion is made of plastic.

6. The firing pin as claimed in claim 5, wherein the annular cushion is made of polyurethane.
